(19) United States
(12) Patent Application Publication
(10) Pub. No.: US 2008/0283550 A1
(43) Pub. Date: Nov. 20, 2008

(54) Beverage Dispenser

(76) Inventors: Richard John Nighy, Stratford on Avon (GB); John Hunter, Rogers, MN (US); Hugh Christopher Bramley, Staffordshire (GB); David Kenneth Njaastad, Palatine, IL (US)

Correspondence Address: PYLE & PIONTEK LLC, 221 N. LASALLE STREET, SUITE 2036, CHICAGO, IL, 60601, US

(21) Appl. No.: 10/586,726

(22) PCT Filed: Jan. 21, 2005
(86) PCT No.: PCT/GB05/00230

§ 371 Date: Jul. 19, 2006

(30) Foreign Application Priority Data
Jan. 21, 2004 (GB) 0401198.7
Apr. 24, 2004 (GB) 0409149.2
May 20, 2004 (GB) 0411246.2
Oct. 8, 2004 (GB) 0422327.7

(51) Int. Cl. G01F 11/00; B67D 5/56; B65D 37/00

(52) U.S. Cl. 222/1; 222/129.1; 222/207; 222/214

(57) ABSTRACT

A method and apparatus for dispensing a post-mix beverage in which a disposable concentrate unit 15 and a disposable pump unit 17 are housed in an upper refrigerated cabinet area 20 of a beverage dispenser 12. The pump unit 17 is operable to dispense metered volumes of concentrate for mixing with a regulated flow of diluent to dispense a required ratiometric mixture thereof.

This invention relates to beverage dispensers and more especially relates to applications of the invention described in our co-pending PCT application of even date herewith, the whole disclosure of which is incorporated herein by way of reference thereto.

Beverage dispensers commonly provide a ratiometric mixture of a beverage concentrate and a diluent and this is commonly done by regulating the flow of two pressurised sources of concentrate and diluent. However, some concentrates are highly viscous and do not flow easily, a problem which is enhanced at the low temperatures at which they are stored. The variance in viscosity means that it is hard to accurately meter a pressurised flow of viscous concentrates, for example orange juice concentrate, and to do so effectively requires a pressure much higher than is conventionally used. This problem is overcome to some degree by current juice dispensers which utilise a positive displacement pump to pump the concentrate and regulate the flow of diluent accordingly.

Another problem associated with the viscosity of some concentrates is that they do not readily mix with a diluent, for example water. This has two adverse effects. The first is that when the beverage is dispensed into a receptacle for consumption there is often found a slug of unmixed concentrate at the bottom of the receptacle which is unappealing to the consumer. Secondly, due to the viscosity and high sugar content of juice concentrates, the concentrate will tend to adhere to the internal components of the dispenser and is not easily cleaned by simple rinsing. This is particularly relevant for example with orange juice concentrate which can become highly toxic through bacterial growth if allowed to sit for long period of time at room temperature. A common contributory factor to these two problems is the non disposable part of the machine through which the concentrate (diluted or undiluted) passes.

There are two systems known in the art which provide a more sanitary system for dispensing concentrate by use of partially disposable components. These are use of a rotary peristaltic pump, the deformable tube of which forms an integral part of the disposable concentrate reservoir, and a positive displacement pump comprising a disposable portion supplied with the reservoir and a non disposable drive to reciprocate the pump, drawing fluid into, and expelling it from, the disposable portion as shown in U.S. Pat. Nos. 5,114,047 and 5,154,319.

Peristaltic pumps provide a reasonable solution but experience problems pumping higher viscosity fluids and as the viscosity of juice concentrate can be highly dependant on its temperature peristaltic systems often do not dispense a correct ratiometric mix of concentrate to diluent at lower temperatures. In addition, the tube part of the pump often deforms to a permanent set over time such that the volumetric output towards the end of its life is less than that at the beginning of its life, again affecting the ratiometric mix of concentrate to diluent.

Positive displacement pumps such as that shown in U.S. Pat. No. 5,114,047 produce a more constant ratiometric mix, however as they have a fill cycle and dispense cycle they intermittently dispense a series of slugs of concentrate into a diluent flow. This does not promote a homogeneous diluted mixture and more importantly the beverage will have a stratified appearance as it exits the dispenser as the concentrate is intermittently dispensed into the diluent stream. This stratified appearance is highly undesirable as it reduces a consumer's perception of the quality of the product being dispensed.

It is further seen as a disadvantage that current systems are operating at their maximum capacity to dispense juice concentrate at the viscosity of current concentration ratios. The lower the concentrate ratio, the higher the proportion of water it contains so, if a higher viscosity, and therefore higher concentration, fluid can be pumped some of the shipping costs associated with the water component of the concentrate can be saved. Additionally the higher the concentrate ration, the greater the number of diluted beverages that can be produced from the same sized reservoir.

It is therefore the purpose of this invention to provide an improved sanitary beverage dispenser capable of volumetrically pumping high viscosity concentrates at a substantially continuous flow rate.

According to a first aspect of the invention there is provided a method of dispensing a post-mix beverage comprising the steps of: inserting into a dispenser a container of beverage concentrate connected to a disposable pump unit, said disposable pump unit comprising a body having a surface at which opens the mouth of a cavity formed in the body, an inlet port for the fluid opening at the surface adjacent to the mouth of the cavity whereby, when the inlet port is open, fluid can flow from the inlet port into the cavity via the mouth thereof, a flexible membrane sealingly secured at its periphery to the surface and overlying the cavity and the inlet port, an outlet port for the fluid, there being a fluid flow passageway extending through the body connecting the cavity to the outlet port, and a flexible membrane sealingly secured at its periphery and overlying the outlet port, the portions of the flexible membrane, where it overlies the inlet and outlet ports respectively, serving as closures for the ports; providing a flow of diluent; driving the disposable pump unit by alternative application of vacuum and pressure by means of a re-usable pump actuator so as to pump a regulated volume of beverage concentrate, the concentrate only coming into contact with disposable parts; regulating the pumped concentrate in such a manner that there is a substantially constant output of concentrate during a dispensing step; regulating the flow of diluent dependant on the quantity of concentrate being pumped in order to maintain a substantially constant ratio of diluent to concentrate; bringing the pumped concentrate flow together with the regulated diluent flow within a section of the disposable pump unit; passing the combined flows together through a mixing means within the disposable pump unit to provide a substantially homogeneous mixture of diluted concentrate; and dispensing the mixture into a receptacle for consumption or storage.

When the reservoir of concentrate is exhausted or otherwise requires replacing, the reservoir and the disposable pump unit may be disposed of and replaced.

Preferably the area into which the container of beverage concentrate is inserted is refrigerated. As is the diluent, although it is to be understood that the present invention is applicable to hot beverages as it is to cold.

In a preferred method the disposable pump unit has a plurality of cavities, preferably two, the volume of each cavity being a fraction of the total volume of concentrate required for one beverage.

Preferably upon insertion of the container of beverage concentrate and the disposable pump unit, the dispenser control system automatically “primes” the or each pump cavity so that the or each cavity is full of concentrate ready to be dispensed.

Preferably the priming time of a cavity is less than the dispensing time of a cavity and the dispense of concentrate from the cavities overlaps such that there is no break in the flow of concentrate as it admixes with the diluent.

In a preferred method the dispenser is pre-programmed with drink sizes which can be selected to dispense a beverage of a known size.

In an alternative preferred method there is provided a continuous pour mode such that the dispenser will continuously dispense the beverage until signalled to stop.

Preferably in either of the above methods there is a time lag between the pour ending or being signalled to stop and the system automatically re-priming the pump and if a pump cavity is half empty when the pour stops and the pour is resumed within said time lag the dispenser will continue to dispense from the same pump cavity without first re-priming thereby providing the system with a ‘top up function’. Preferably, after the time lag has expired the dispenser primes all the pump cavities.

Preferably a signal comprising data indicative of the concentrate or required pumping properties and the control of the concentrate flow rate is automatically set by these concentrate properties. In a preferred method the signal is automatically detected by the dispenser by reading data stored on a radio frequency identification (RFID) tag or an Electro-Erasable-Programmable-Read Only Memory (EEPROM) chip attached to the concentrate reservoir or the disposable pump unit. Alternatively the signal may be inputted by an operator manually or through a handheld device.

Preferably there is a means of sensing the concentrate flow continuity and where there is a flow discontinuity between dispense from the individual pump chambers, adapting control of the pump to eliminate the discontinuity. In a preferred method the sensing means monitors the build up of pressure and vacuum acting on the flexible membrane covering the pump cavity. Alternatively a visual sensor may be used to detect flow discontinuity of the concentrate being pumped.

The data may also, for example, contain data relating to the shelf life of the concentrate such that a beverage will not be dispensed if the concentrate contained within the reservoir is not within its shelf life. The data may also identify the volume of product in the reservoir, and the size of the doses it is dispensing, allowing a count down of the remaining doses of concentrate in the reservoir. Preferably the number of dispenses remaining can be displayed and/or a warning is made prior to the reservoir running out.

In a preferred method the dispenser additionally has the capability of writing information back to the identification means. Alternatively the control electronics has a memory in which it stores data for each reservoir for a limited amount of time after it is removed from the dispenser.

Preferably if a part-used reservoir is replaced in the dispenser after having been previously removed, the dispenser will recognise it if and when it is replaced and knows the volume of concentrate it is still containing.

Preferably the temperature of the concentrate is monitored and the control of the disposable pump unit is modified dependent on the temperature.

According to a second aspect of the invention there is provided a beverage dispenser for dispensing a post-mix beverage from disposable pump unit comprising a body having a surface at which opens the mouth of a cavity formed in the body, an inlet port for the fluid opening at the surface adjacent to the mouth of the cavity whereby, when the inlet port is open, fluid can flow from the inlet port into the cavity via the mouth thereof, a flexible membrane sealingly secured at its periphery to the surface and overlying the cavity and the inlet port, an outlet port for the fluid, there being a fluid flow passageway extending through the body connecting the cavity to the outlet port, and a flexible membrane sealingly secured at its periphery and overlying the outlet port, the portions of the flexible membrane which overlie the inlet and outlet ports respectively serving as closures for the ports, comprising: a diluent supply system to supply a regulated flow of diluent to a section of the disposable pump unit; a cabinet area for receiving at least one reservoir of concentrate; at least one pumping station for receiving, retaining and actuating a disposable pump unit, a control system for controlling the metering of the concentrate and the flow rate of the diluent to dispense a required ratiometric mixture thereof.

Preferably the beverage dispenser further comprises a lower section containing a diluent cooling means (where the beverage is a cold one); an upper section, comprising the cabinet area for storing one or more containers of concentrate; and a pumping section positioned between said lower and upper sections, said pumping section comprising one or more pumping stations, each station having a drive face to which the flexible side of a disposable pump unit is presented, said drive face being in fluid communication with sources of pressure and partial vacuum and having associated first and second valve actuators to open and close the inlet and outlet ports of the disposable pump unit, and clamping means for clamping the disposable pump unit in place.

Preferably the diluent supply comprises a diluent, e.g. water, inlet to the dispenser, adiluent cooling means, a flow meter to detect the flow of the diluent and a flow control valve to control the flow of the diluent. Preferably the flow meter is a turbine flow meter and the control valve is a variable orifice valve.

In one preferred arrangement the flow control valve also acts to shut off the flow when no diluent is required. Alternatively an additional on/off diluent valve may be provided.

Preferably the diluent is supplied to the clamping means and is interfaced, via the clamping means, with the disposable pump unit when the clamping means is secured in place. Preferably, immediately upstream of its interface to the disposable pump unit the diluent line is provided with a fluid closure which has a positive crack pressure to retain any diluent within the line during changing the disposable pump unit. Preferably the fluid closures are those which open under a small applied pressure differential and elastically recover to seal under normal conditions. For example, the SureFlo™ Valve from Liquid Molding Systems, Inc. is suitable.

Preferably, the diluent cooling system, if present, comprises a refrigerated water bath containing a refrigerant coil around its periphery upon which builds a bank of ice, and a diluent coil situated in the liquid phase of the water bath and through which the diluent passes. The refrigerant coil is powered by standard refrigerants as known in the art.

Preferably the cabinet area for receiving a reservoir of concentrate is refrigerated by an air blown system as known in the art. Preferably at least one temperature probe is provided within the area to monitor the temperature within the cabinet area. Preferably there is provided a rigid retaining enclosure into which a flexible reservoir, e.g. bag, of concentrate can be placed prior to installation into the cabinet area. Preferably the bottom interior surface of the retaining enclosure is angled (preferably in the region of 12-20 degrees), such that when in situ the concentrate within the reservoir will tend to drain under the influence of gravity to the lower front of the reservoir to which the disposable pump unit is attached. Preferably the top of the rigid container has a retaining means to retain the upper edge of the flexible reservoir to aid drainage of the concentrate to the lower section. Preferably the lower surface of the cabinet area is at an angle which corresponds to the angle on the bottom of the rigid retaining enclosure. Preferably the rigid enclosure has a hole therein which aligns with the temperature probe which protrudes from the cabinet area such that in use it contacts directly with the flexible reservoir within the rigid enclosure in an area in proximity to the disposable pump unit giving a temperature reading substantially indicative of the temperature of the fluid being pumped.

Preferably the drive face of the pumping station has a number of concave recesses therein corresponding and aligning with the pump cavities of the disposable pump, each recess having therein a port which communicates via pressure and vacuum lines with sources of pressure and partial vacuum respectively.

Preferably the source of pressure comprises a pressure pump, a pressure release valve and a pressure regulator to control the pressure being provided to the disposable pump unit. The pressure regulator is preferably electronically variable, the pressure being automatically regulated dependent on the viscosity of the concentrate which is being pumped. Preferably a 2/2 (on/off) valve is also associated with each recess on the drive face, the 2/2 valve being used to switch the vacuum/pressure and the regulator being used to regulate it. In an alternative arrangement, a high-speed pulsed digital valve may be used to combine the features of the regulating and switching the positive pressure, eliminating the need for separate valves.

Preferably the supply of partial vacuum is provided by means of a vacuum pump which leads to one or more 2/2 valves, each of which is associated with a recess on the drive face. Preferably a sensor is provided in the partial vacuum line to detect if there is any concentrate in the line. In a preferred arrangement the sensor is a visual sensor which detects the passage of light across a clear section of the vacuum line, said passage of light being obstructed should there be concentrate present in the line. Alternative methods of sensing concentrate in the vacuum line will be apparent to those skilled in the art.

In one preferred arrangement a pressure reservoir and a partial vacuum reservoir are provided in the pressure and vacuum lines respectively. Preferably a drain is provided in the bottom of each of these reservoirs which is selectively openable.

The first valve actuator protrudes through the drive face of the pumping station into the recess therein and is operable to selectively move the flexible membrane onto the lip of the inlet port within the cavity of the disposable pump unit to close the inlet port. Preferably the first valve actuator is driven by a solenoid.

The second valve actuator associated with, and adjacent to, each recess is actuated to selectively move the flexible membrane of the disposable pump unit onto a lip surrounding an outlet port associated with, but distinct from, the pump cavity to close the pump outlet port. Preferably the second valve actuator is driven in a proportional manner such that the degree of opening or closing of the outlet port can be controlled to vary the outlet flow. This is preferably achieved by means of a stepper motor.

Preferably the stepper motor control is overdriven into its closed position and then re-zeroed every time the outlet port is closed. This eliminates accumulated errors which can occur in stepper motors due to, for example, missed steps and compensates for different dimensional requirements due to tolerances in manufacturing and assembly.

A seal is provided between the first and second valve actuators and the drive face of the pumping station, providing, together with a gasket which surrounds the recess in the drive face, a sealed and enclosed volume between the membrane covering the cavity of the disposable pump unit and the recess in the drive face thus enabling the application of pressure and partial vacuum to said enclosed volume to move the membrane and thereby pump concentrate. Preferably the seals between the valve actuators and the drive face are rolling diaphragm seals.

Preferably the first and second valve actuators are provided with soft tips so that no damage is done to the flexible membrane as it is pressed against the lip of a port.

Preferably the pumping station is adapted to receive a disposable pump unit having two pump cavities.

Preferably the beverage dispenser comprises a plurality of pumping stations.

Embodiments of the invention will now be described, by way of example only, with reference to the accompanying drawings in which:

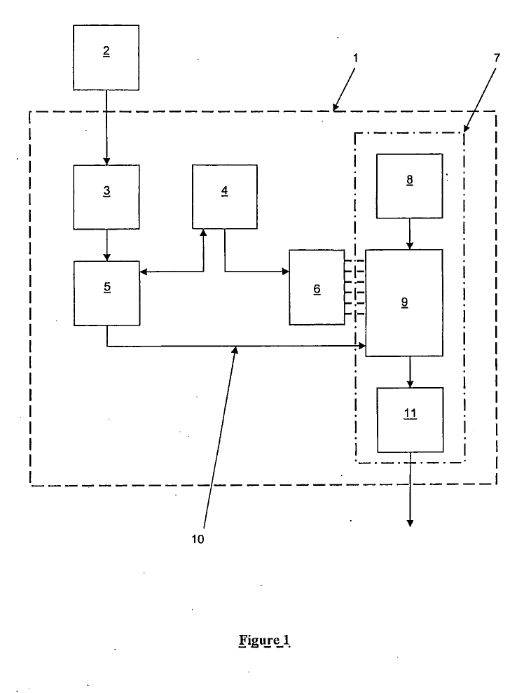

FIG. 1 is a schematic diagram of a dispenser in accordance with the invention;

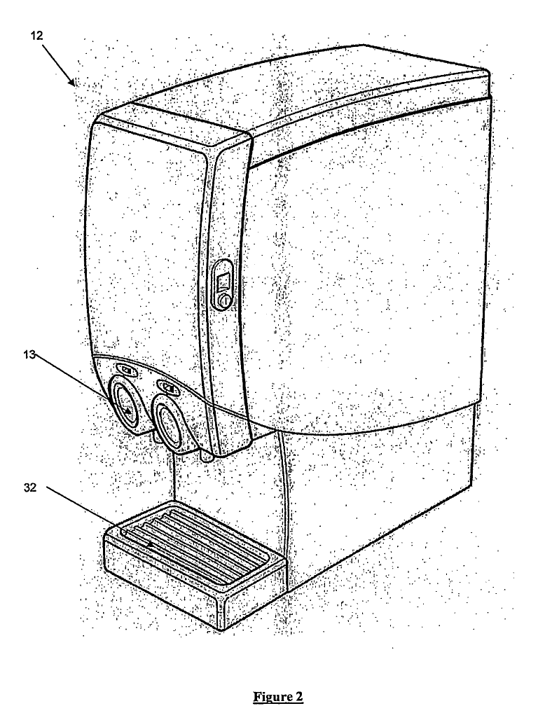

FIG. 2 is a diagram of a dispenser in accordance with the invention;

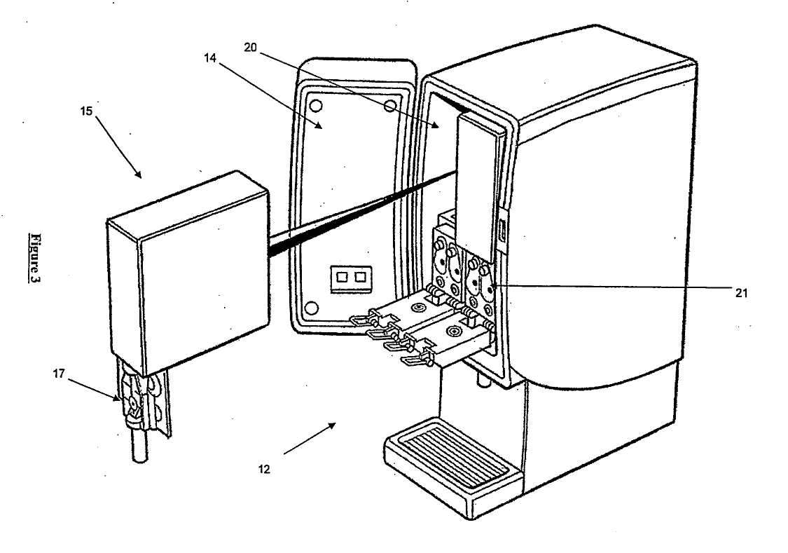

FIG. 3 is a diagram of a dispenser in accordance with the invention with the front cover open and the retainer plates open;

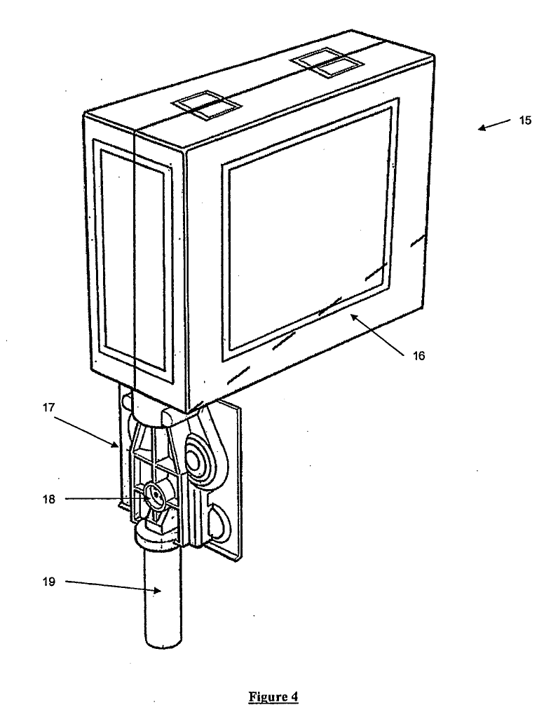

FIG. 4 is a diagram of a disposable reservoir and pump unit in accordance with the invention;

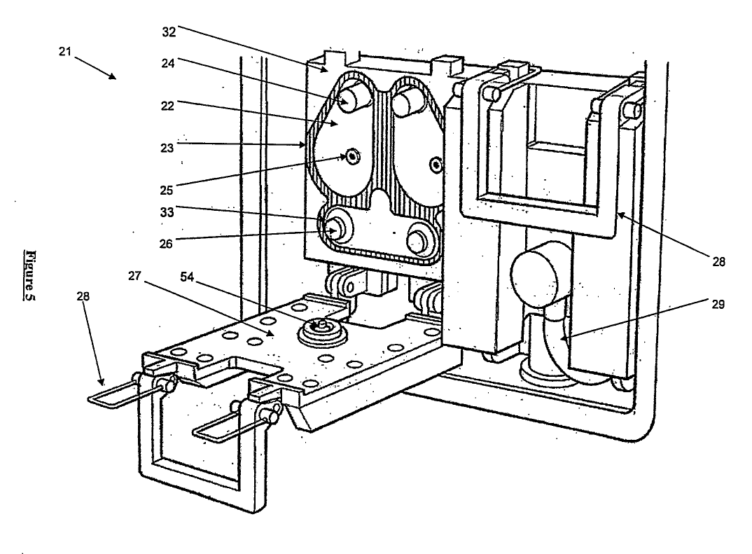

FIG. 5 is a diagram of a close up view of the drive face and retaining place for the disposable pump cartridge of a 2 beverage dispenser in accordance with the invention, one beverage side shown in its open position, the other being shown in its closed position;

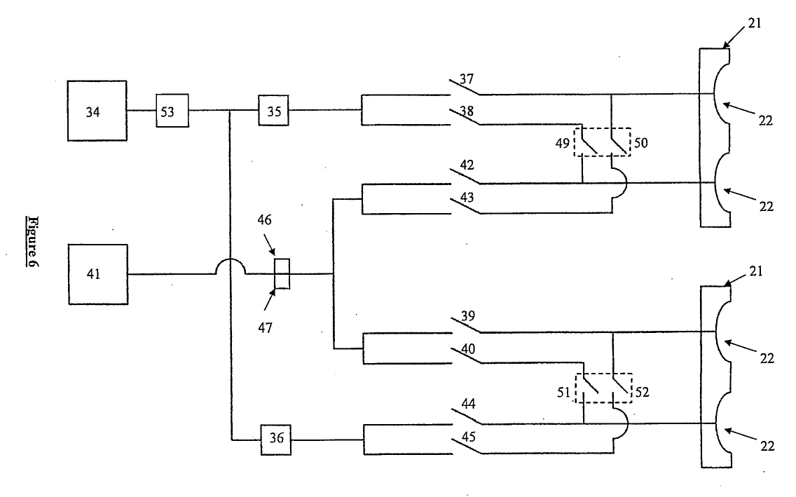

FIG. 6 is a schematic diagram of the fluid control circuit for actuating a disposable pump unit of a beverage dispenser in accordance with the invention;

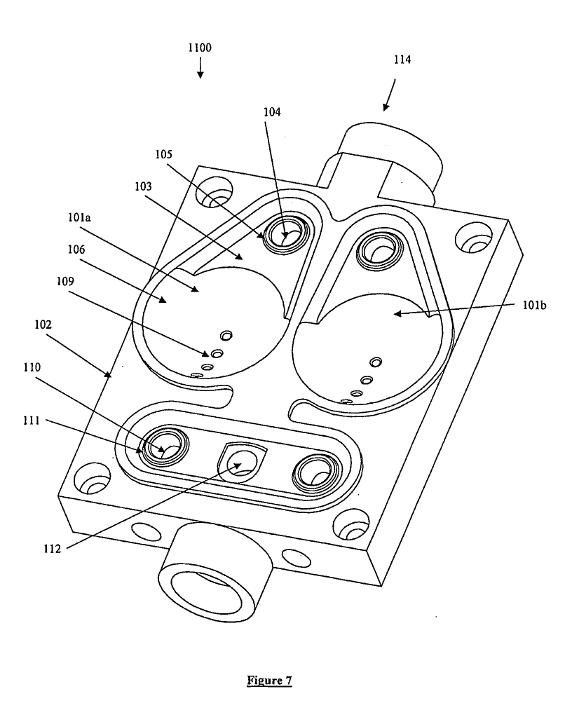

FIG. 7 is a perspective view of a disposable pump unit;

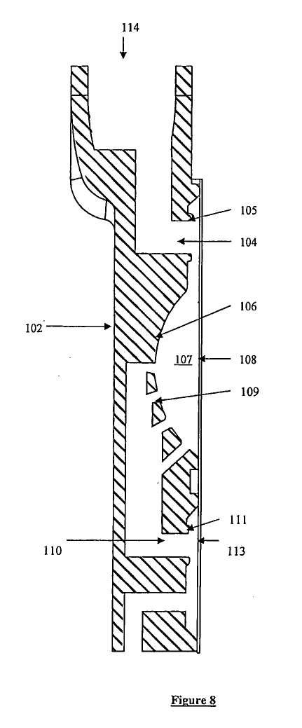

FIG. 8 is a longitudinal cross-section of the disposable pump unit of FIG. 7;

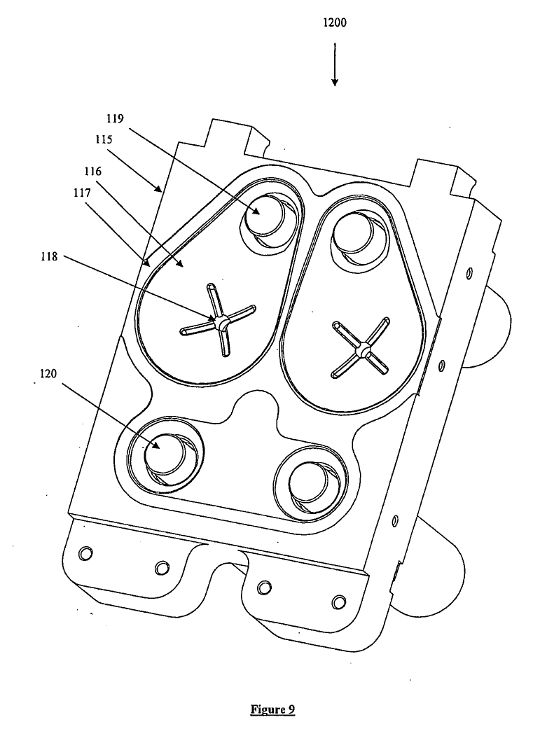

FIG. 9 is a perspective view of a pump actuator for assembly with the pump unit shown in FIGS. 7 and 8;

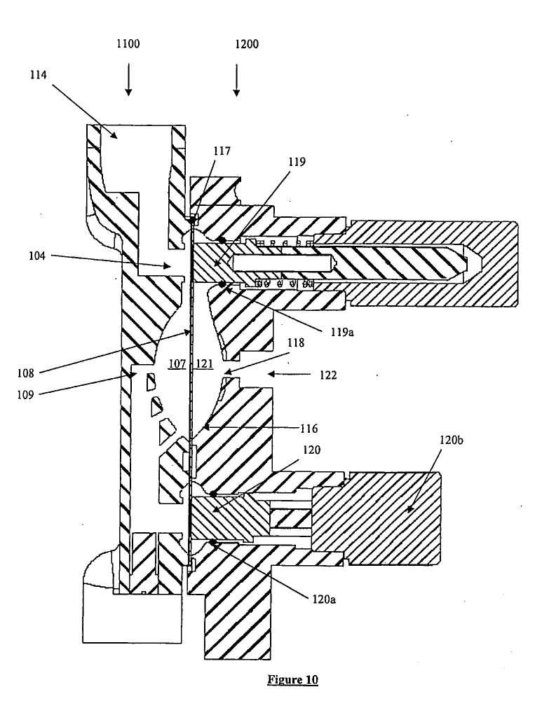

FIG. 10 is a cross-section of the assembled pump unit and pump actuator;

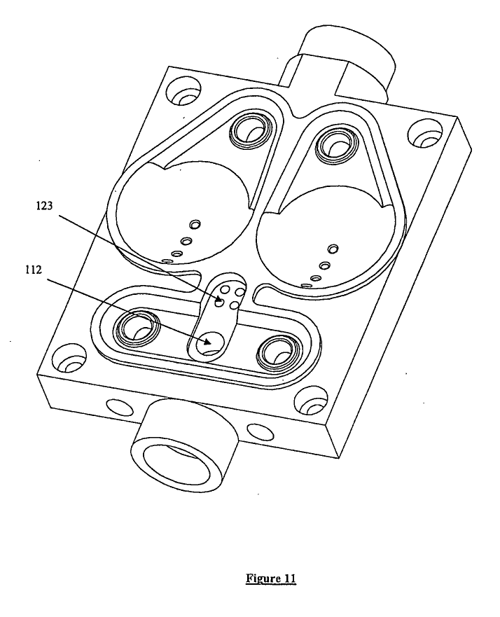

FIG. 11 is a perspective view of the pump unit shown in FIG. 7 additionally having a diluent inlet;

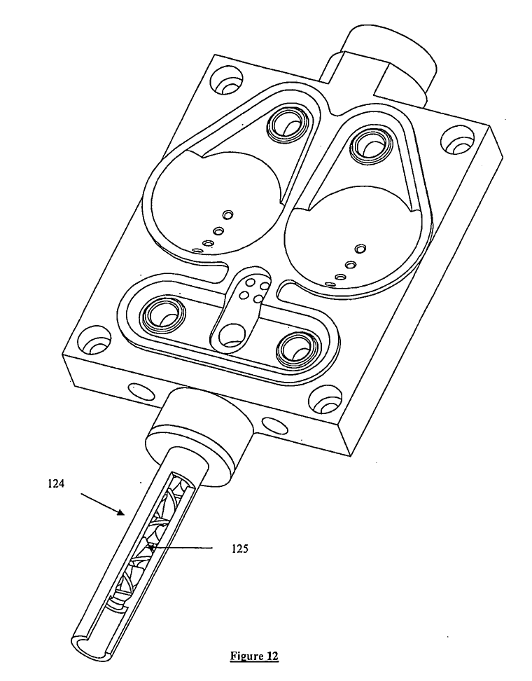

FIG. 12 is a similar view to FIG. 11, but in which the pump outlet has an integral convoluted path mixing section;

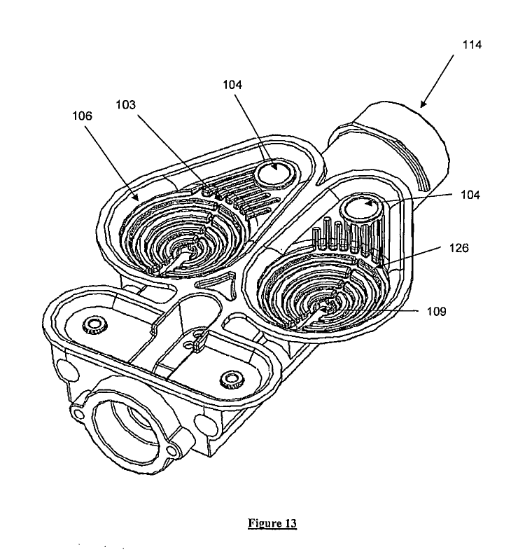

FIG. 13 is a perspective view of a disposable pump unit showing the channels provided for prevention of occluded volumes of fluid in the pump;

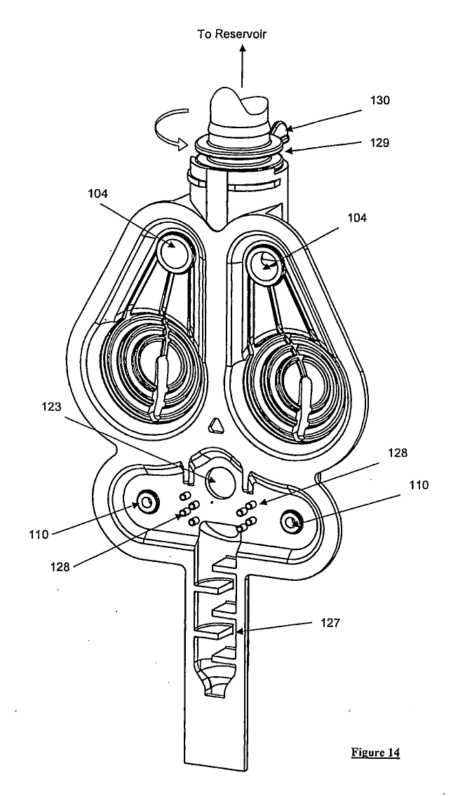

FIG. 14 is a perspective view of a disposable pump unit showing the closure between the pump unit and the reservoir; and

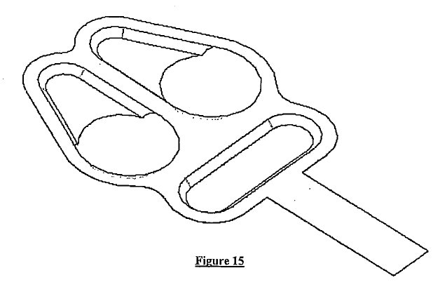

FIG. 15 is a perspective view of a pre-formed membrane for use with the disposable pump unit.

Referring to FIG. 1, a schematic diagram of a beverage dispenser is shown in which a beverage dispenser 1 is connected to a diluent supply 2, which may be a continuous supply, for example a supply of mains water. When it enters the dispenser the diluent is cooled in a cooling unit 3 using a water bath heat exchanger which comprises an outer coil through which a refrigerant passes, cooling the water and forming a bank of ice surrounding the refrigerant coil, the ice bank maintaining a constant temperature within the water and a reserve of cooling energy to maintain that temperature. In the liquid phase of the water bath is a secondary coil through which the water passes, cooling as it does so to a temperature commonly in the region 2 to 6 degrees centigrade. The flow of the diluent is measured using traditional flow measurement techniques for example a flow turbine flow sensor. Control electronics 4 receive signals from a flow sensor and, by means of control valve 5, control the diluent flow. The control valve 5 may be of any proportional type, for example a proportional solenoid but is preferably a variable orifice type valve as described in UK patent GB2348185. The control electronics also controls and the pump actuator 6. Situated within or attached to the dispenser 1 is a disposable concentrate unit 7 comprising a concentrate reservoir 8, a dual-cavity pump unit 9 connected to the concentrate reservoir 8, a diluent conduit 10, and a static mixer 11 to mix the concentrate and diluent to form a homogeneous mixture.

Referring to FIGS. 2 to 5, a dispenser 12 is shown with a user interface 13 to allow the user to select to dispense a beverage. The door 14 of the dispenser opens to allow the user to load and unload the disposable concentrate unit 15. The disposable concentrate unit 15 consists of a flexible reservoir (not shown) connected to a dual cavity pump unit 17 which has a diluent inlet 18 and a static mixer 19. The flexible reservoir is placed within a re-usable rigid container 16 which supports the flexible reservoir. Optionally the re-usable rigid container 16 may have an angled lower surface of approximately 15 degrees so that under the influence of gravity the concentrate will tend to flow towards the dual cavity pump unit 17 The diluent enters the pump unit 17 downstream of the cavities which pump the concentrate and the pumped concentrate and the diluent then flow together to a static mixer 19 which uses turbulence and fluid shear as the admixture passes therethrough to produce a homogeneous mixture.

The disposable concentrate unit 15 and disposable pump unit are placed in the dispenser 12 such that both are within the refrigerated area of the dispenser 12 and the pump unit 17 is positioned such that it interfaces with the pumping station 21, of which two are situated within the dispenser 12. By maintaining both the pump unit and the reservoir in the refrigerated section any juice within the cavities of the disposable pump unit is maintained at its refrigerated temperature. The re-usable rigid container is preferably of a 2 part hinged construction for ease of use and may optionally have a angled lower surface as represented by the dashed line in FIG. 4 to aid the concentrate to drain, under the influence of gravity, towards the disposable pump unit 17. An angle of the surface of approximately 15 degrees was found to be most beneficial. The upper refrigerated cabinet area is cooled by means of a standard air blown refrigeration system which is preferably a common system with that used to refrigerate the cooling unit 3. The temperature of the concentrate in this cabinet area 20 is monitored by use of temperature sensors (not shown) this can be done in one of two ways, firstly the general temperature of the air within the cabinet 20 can be monitored and this be assumed as the temperature of the concentrate. However it is preferable that a ore direct measure of the concentrate be taken. As this is a sanitary system it is highly undesirable to insert any kind of temperature sensor into the concentrate so a temperature sensor extends into the cabinet in such a manner that it passes through an opening in the rigid container 16 and contacts the flexible reservoir. This temperature sensor is provided in a region immediately adjacent to the disposable pump unit inlet such that the sensed temperature is substantially representative of the temperature, and therefore viscosity, of the concentrate as it passes into the cavities of the disposable pump unit.

The pumping station 21 comprises a drive face 32 contains two recesses 22 surrounded by a gasket 23 with which the cavities of the disposable pump unit 17 align thereby forming a sealed volume between the pump unit and the recesses 22. Positioned within each recess 22 is a valve actuator 24 with a soft tip which when actuated bears on the flexible membrane covering the cavity of the disposable pump unit 17 thereby urging the membrane into sealing contact with a raised lip within the cavity (not shown). The recesses 22 have ports 25 in their surface which are in connection with a switchable supply of partial vacuum and pressure which applied alternatively empty and fill the cavities with concentrate from the reservoir 16. The pumping station 21 has outlet valve actuators 26 which move to open and close a membrane on an orifice on the pump unit. The outlet valve actuators 26 are driven by a stepper motor so that they can be incrementally opened to define a required outlet flow from the pump cavities. Between the inlet valve actuators 24 and the recess, and the outlet valve actuators 26 and the drive face is provided a rolling diaphragm seal 33 which maintains the integrity of the sealed volume and further prevents ingress of fluid or particulate matter into the interior of the dispenser. The disposable pump unit 17 and the pump actuator form the subject matter of our PCT application of even date and the construction and operation thereof is described later with reference to FIGS. 7 to 15.

When the pump unit 17 is in place, a retainer plate 27 hinges into place and is clamped by clamps 28 to seal the edges of the pump unit 17 against gasket 23 to form a fluid tight seal. The retainer plate 27 is supplied with diluent via diluent line 29 which communicates with the pump unit 17 wherein the diluent mixes with the pumped concentrate prior to passing through a mixer 19. In the diluent line 29 as it passes through the retainer plate 27, is provided a closure 54 which maintains the un-pressurized diluent in the diluent line 29 when the pumping station 21 is in its open position for removal on insertion of a pump unit 17.

Referring to FIG. 6 a schematic diagram is shown of the control circuit used to pump the concentrate in a two pump station unit adapted for dual cavity pump units. A pressure pump 34 feeds two pressure regulators 35 36, one for each pumping station 21 via a pressure relief valve 53. The provision of separate regulators for the two pumping stations 21 enables beverages using concentrates of different viscosity to be simultaneously dispensed. Between each regulator 35, 36 and each recesses 22 of the cavities is provided a 2/2 valve 37, 38, 39, 40 which control the flow of regulated air to each recess 22. A vacuum pump leads directly to each recesses 22 via a 2/2 valve 42, 43, 45, 46 which control the application of vacuum to the recesses. Situated in the section of the vacuum line prior to the valves and common to all recesses is a light source 46 and a light sensor 47 facing each other across a clear section of the vacuum line such that under normal operating conditions light from the source 46 passes through the line and is detected by the sensor 47, but if there is a rupture in the disposable pump (17 FIG. 4) abutting the recesses resulting in concentrate being drawn into the vacuum line the light bath becomes blocked and a warning can be issued to shut down the machine prior to concentrate being drawn into the vacuum pump. Optional valves 49, 50, 51, 52 of the 3/2 variety are provided which act as vent valves, venting each recess between the application of pressure and vacuum to restore it to atmospheric pressure, thereby reducing the duty of the vacuum and pressure pumps.

Referring to FIGS. 3, 4, 5 and 6, the method of pumping from a pump unit 17 in one of the pumping stations 21 is as follows. Initially, for changing the disposable pump unit and concentrate reservoir, valves 37 through 40 and 42 through 45 are shut. When a disposable pump zone 17 is in place, the retainer plate 27 is clamped in place, and the door 14 is shut the dispenser automatically primes the system. The vacuum pump 41 starts and valves 42 and 43 open to create a partial vacuum in the volume created between the recesses 22 in the drive face 25 and the cavities in the disposable pump unit. Inlet valve actuators 24 are activated to create an open flow path between the reservoir of concentrate and the cavity of the pump chamber. The partial vacuum draws the flexible membrane covering the cavities towards and into the recesses 22 in the drive face 25 which draws concentrate from the reservoir into the pump cavity. thereby filling it. To pump concentrate from the disposable pump unit, the inlet valve actuators 24 will close, the vacuum pump 41 will stop and valves 42 and 43 will close. The pressure pump 34 will then start and one of the valves 37 or 38 corresponding to the first cavity to be pumped will open, followed by the outlet valve actuator 36 associated with the outlet of that cavity opening. The pressure on the membrane forces it back towards the disposable pump unit and into the cavity thereof, forcing the concentrate therein out of the cavity outlet and through the open outlet valve where after it will mix with a diluent to produce the beverage. Prior to the cavity being completely evacuated the other valve 37 or 38 not already open will open as will the other outlet valve actuator 36 such that the dispense from the two cavities overlaps. Once one of the cavities is empty the outlet valve actuator 36 and the pressure line valve 37 or 38 associated with it will close, the vacuum pump will start and the valve 42 o 43 associated with that cavity will open drawing fluid into the empty cavity in the same manner as when the pump was primed. This cycle can be repeated as many times as necessary to pump he required amount of concentrate for a beverage. Optionally, once one of the cavities is empty then between the outlet valve actuator 36 and the pressure line valve 37 or 38 associated with it closing and valve 42 o 43 associated with that cavity opening, vent valve 49 or 50 associated with that cavity may open to restore the pressure within said cavity to atmospheric pressure.

Referring now to FIGS. 7 to 15, the construction and operation of the pump unit and actuator unit is now described in more detail.

Referring to FIGS. 7 and 8, a dual-chamber disposable pump unit 1100 is shown. A fluid inlet 114 splits to feed each of the two pump cells 101a, 101b comprised in a rigid body 102 having on a substantially flat surface thereof an area 103 containing a chamber inlet port 104, the inlet port 104 being surrounded by a raised lip 105, and a concave cavity 106 defining one side of a pump chamber 107. The second side of the chamber 107 comprises a membrane 108 made of a flexible sheet material, e.g. low density polyethylene (LDPE), sealingly secured about its periphery to the aforesaid surface of the body 102 so as to enclose each fluid inlet area 103 and their respective concave cavities 106 such that fluid can pass from the inlet port 104, when open, to the respective concave cavities 106. Located in each concave cavity 106 of each pump chamber 101a, 101b is an array of chamber outlets 109. Each chamber outlet 109 is in fluid communication with a closable outlet port 110 surrounded by a raised lip 111. The flow paths from the two closable outlet ports 110 converge together into a single outlet 112. The two closable outlet ports 110 and the outlet 112 are together sealingly enclosed by a membrane 113 comprising flexible sheet material, shown to be integral with the membrane 108, secured about its periphery to the aforesaid surface of the body 102.

Referring to FIG. 9, a non-disposable pump-actuating unit 1200 for the dual chamber pump unit 1100 is shown. The actuating unit 1200 comprises a rigid body 115 containing two concave cavities 116, each surrounded by a gasket seal 117. The concave cavities 116 and the gasket seal 117 are shaped such that they match the shape of the pump cells 101a, 101b so that when placed in contact with them they form a seal around the circumference of the pump cells 101a, 101b. Located within each cavity 116 is a compressed air inlet/exhaust port 118 defined in part by cross-shaped channels extending over a substantial basal area of the cavity 116. Also located within each cavity 116 is a solenoid-operated armature 119 which extends through the body 115 and into the cavity 116. A pair of armatures 120 also extends through the body 115 adjacent to the cavities 116.

Referring to FIGS. 7, 8 and 10, the pump-actuating unit 1200 is shown in FIG. 10 to be releasably connected to the disposable pump unit 1100 to form a complete pump. The cavity 116 in the unit 1200 together with the membrane 108 forms an actuating chamber 121 connectable alternately to supplies of negative and positive pressure air via a passageway 122. Each cavity 116 in the pump-actuating unit 1200 and its opposed cavity 106 in the disposable pump unit 1100 together define a fixed volume of fluid that will be displaced on each cycle of the pump. The sequence of operation of the pump is that each armature 20 extends so as to urge the membrane 113 locally onto the respective raised lips 111 of the outlet ports 110 thus closing the pump chamber outlet, and the armature 119 is spaced from the membrane 108 such that the flow path between the inlet port 104 and the concave cavity 106 is open. Armatures 119 and 120 have associated seals 119a, 120a, which prevent ingress of any substances past the armatures.

A first source of pump actuating fluid at a negative pressure, ie below ambient pressure, is connected to the actuating fluid port 118 via the passageway 122, the application of the negative pressure causing the flexible membrane 108 to be drawn towards and into the cavity 116 thereby drawing fluid into the latter from a reservoir (not shown) via the inlet 114 and the inlet port 104, the inlet port 104 being held open by the negative pressure tending to lift the membrane 108 locally away from the inlet port 104. The cross-shaped channels of the port 118 ensure that the membrane 108 can be drawn fully into the cavity 116 and prevents the membrane 108 from blocking the port 118 before the membrane 108 is substantially fully withdrawn into the cavity 116. When the membrane 108 is fully drawn into the cavity 116 and the volume defined by the cavity 116 and the cavity 106 is filled or substantially filled with the fluid to be dispensed, the armatures 119 and 120 are actuated such that armature 119 is moved towards the pump cell, locally pressing the membrane 108 against the raised lip 105 of the inlet port 104 to close the flow path between the inlet 114 and the pump chamber 107, and armature 120 moves away from the outlet port 110 allowing the membrane 113 to move away from the outlet port 110 of the pump cell outlet (112, FIG. 7). Substantially at the same time, positive air pressure is applied to the membrane 108 via the port 118 which urges the membrane 108 towards and substantially fully into the cavity 106 whereby the fluid is pumped out through the outlet 112 via the outlet port 110. The pump filling/dispense cycle may then be repeated. The outlet armatures 120 are attached to stepper motors 120b which can vary the position of the each 120 in relation to the raised lip 111 of its respective outlet port 110 thereby allowing the opening of the outlet valve to be controlled to vary the outlet flow of the pump.

In operation, the two pump cells may be operated in opposite phase such that when one is dispensing the other is filling, the filling cycle preferably being faster than the dispense cycle such that there can be a slight overlap of the dispensing cycles to ensure constant output. If there are more than two pump cells then it is not necessary for the filling cycle to be faster than the dispense cycle.

Referring to FIG. 11, a pump unit is shown which is similar to that shown in FIG. 7 and operates in the same manner, but which has the additional feature of a diluent inlet 123 through which a diluent enters the pump cell and mixes with the pumped fluid to pass with it through the pump cell outlet 112 whereby diluted fluid is dispensed. The flow of the diluent is controlled by means of an external control valve (not shown) which may be variable and controlled to give a constant ratiometric mixture of pumped fluid to diluent.

Referring to FIG. 12, a pump unit is shown which is similar to that shown in FIG. 11 and operates in the same manner. However, in addition, it comprises a mixing section 124 downstream of the point at which the diluent is added. Where the pumped fluid is of a high viscosity (e.g. above 10,000 centipoises) it becomes increasingly difficult to obtain a homogeneous diluted fluid; the convoluted path 125 of the mixing section 124 is designed to shear the viscous fluid and create turbulence to ensure that the two components mix fully.

Referring to FIG. 13 a rigid plastic pump unit is shown comprising of a fluid inlet 114 leading to two chamber inlet ports 104 from which there is a flowpath to the concave cavity 106 and its associated chamber outlet 109, Provided in surface of the concave cavity 106 and the flat area 103 are recessed grooves 126 which, should the flexible film (not shown) trap an occluded area of the pumped fluid remote from the chamber outlet 109, there will always be a channel for the fluid to be forced out of ensuring that the chamber is fully emptied every, thus giving a repeatable volumetric output. The pump unit shown in this figure has had all excessive plastic removed and designed for production by injection moulding techniques.

Referring to FIG. 14 the rigid plastic pump unit of FIG. 13 is shown further comprising an integrated static mixer 127 which is formed as a feature of the plastic moulding enclosed by the flexible film which is heat welded thereover. Additionally an array of obstructions 128 are provided between the outlet ports 110 and the static mixer 127 such that the fluid is sheared immediately prior to it admixing with the diluent entering via diluent inlet 123. Once admixed with the diluent the fluid passes through the static mixer 127 and is dispensed therefrom as a homogeneous fluid. In the fluid inlet (114, FIG. 13) is a closure 129 which is rotatable by means of lever 130 to open or close the flow from the reservoir (not shown) to the inlet ports 104.

Referring to FIG. 15 a pre-formed flexible membrane suitable to be heat welded to a pump zone of the invention is shown.

1-61. (canceled)

62. A method of dispensing a post-mix beverage, comprising the steps of:
inserting into a beverage dispenser a container of beverage concentrate connected to a disposable pump, the disposable pump comprising a body having a surface at which opens the mouth of a cavity formed in the body, an inlet port for the concentrate opening at the surface adjacent to the mouth of the cavity whereby, when the inlet port is open, concentrate can flow from the inlet port into the cavity via the mouth thereof, an outlet port for the concentrate, a concentrate flow passageway extending through the body connecting the cavity to the outlet port, and a flexible membrane sealingly secured at its periphery to the body and overlying the cavity and the inlet and outlet ports, the portions of the flexible membrane, where the membrane overlies the inlet and outlet ports, serving as closures for the ports; providing a flow of diluent; driving the disposable pump by alternate application of vacuum and pressure to a side of the flexible membrane opposite from the cavity by means of a reusable pump actuator, so as to draw concentrate through the inlet port and into the cavity to fill the cavity and to then pump and dispense a regulated volume of beverage concentrate from the cavity and through the passageway to and through the outlet port, the concentrate only coming into contact with the disposable pump; regulating the pumped concentrate to provide a substantially constant output of concentrate during dispensing; regulating the flow of diluent in accordance with the flow of concentrate being pumped to maintain a substantially constant ratio of diluent to concentrate; bringing the pumped concentrate flow together with the regulated diluent flow within a section of the disposable pump; passing the combined flows through a mixer to provide a substantially homogeneous mixture of diluted concentrate; and dispensing the mixture into a receptacle.

63. A method according to claim 62, including the step of refrigerating the container of concentrate within the beverage dispenser.

64. A method according to claim 62, wherein the disposable pump has a plurality of cavities, the volume of each of which is a fraction of the total volume of concentrate required for a beverage, and said driving step is performed such that concentrate is drawn into and pumped from each of the cavities.

65. A method according to claim 64, wherein the disposable pump has two cavities.

66. A method according to claim 64, including the step, upon insertion of the container of beverage concentrate and disposable pump into the beverage dispenser, of performing said driving step to fill each pump cavity.

67. A method according to claim 64, wherein said driving step is performed such that the time required to fill a cavity with concentrate is less than the time to pump concentrate from a cavity and such that the pumping of concentrate from the cavities is overlapped, so that there is no break in the flow of concentrate as it is brought together with the diluent.

68. A method according claim 62, wherein said driving step is performed so as to dispense selected different beverage sizes, and including the step of selecting a particular size of beverage to be dispensed.

69. A method according to claim 62, wherein said driving step is performed so as to continuously dispense beverage until signaled to stop.

70. A method according to claim 64, wherein said driving step is performed such that there is a time lag between termination of pumping concentrate from a cavity and filling of the cavity with concentrate, and including the step, performed if a pump cavity is not empty when pumping concentrate from the cavity terminates and dispensing beverage resumes within the time lag, of continuing to dispense from the cavity without first refilling the cavity, thereby providing a top-up function.

71. A method according to claim 70, including the step, after the time lag expires, of driving the pump to fill all of the pump cavities.

72. A method according to claim 62, including the steps of providing a signal comprising data indicative of the pumping properties of the concentrate, and controlling said driving step to control the flow of pumped concentrate in accordance with the signal.

73. A method according to claim 72, wherein said signal providing step is performed by attaching an identifier to at least one of the concentrate container and disposable pump, the identifier carrying the data indicative of the pumping properties of the concentrate, and including the step of automatically detecting the data stored in the identifier and generating the signal in response thereto.

74. A method according to claim 72, wherein said providing step is performed manually.

75. A method according to claim 64, including the steps of sensing concentrate flow continuity and, in response to a sensed flow discontinuity between dispenses from individual ones of the pump cavities, controlling the pump to eliminate the discontinuity.

76. A method according to claim 75, wherein said sensing step is performed by monitoring vacuum and pressure applied to the flexible membrane to fill the pump cavities with concentrate and dispense concentrate from the pump cavities.

77. A method according to claim 75, wherein said sensing step is performed through use of an optical sensor to detect concentrate flow continuity and discontinuity.

78. A method according to claim 73, wherein the data indicative of the pumping properties of the concentrate includes a shelf life of the concentrate, and including the step of preventing performance of said driving step if the concentrate in the container is not within its shelf life.

79. A method according to claim 72, wherein the data indicative of the pumping properties of the concentrate includes the volume of product in the container and the sizes of doses of concentrate being dispensing, and including the step of determining the number of doses of concentrate remaining in the container.

80. A method according to claim 79, including the step of displaying one or both of the number of doses of concentrate remaining in the container and a warning that no more than a predetermined number of doses of concentrate remain in the container.

81. A method according to claim 73, including the step of operating the beverage dispenser to write information back to the identifier.

82. A method according to claims 72, wherein the beverage dispenser includes control circuitry having a memory, and including the steps of writing to the memory data indicative of the pumping properties of each concentrate inserted into the beverage dispenser, and storing in the memory such data for each container of concentrate for a selected time after the container is removed from the beverage dispenser.

83. A method according to claim 82, including the step, performed upon a partially used reservoir being reinserted into the dispenser within the selected time after having been previously removed, of reading from the control circuit memory the number of doses of concentrate remaining in the container.

84. A method according claim 62, including the steps of sensing the temperature of the concentrate, and controlling said driving step in accordance with the sensed temperature.

85. A beverage dispenser for dispensing a post-mix beverage, said beverage dispenser comprising: a disposable pump including a body having a surface at which opens a mouth of a cavity formed in said body, an inlet port for connection with a reservoir of beverage concentrate and opening at said surface adjacent to said mouth of said cavity whereby, when said inlet port is open, concentrate can flow from said reservoir to and through said inlet port and into said cavity via said mouth thereof, an outlet port for the concentrate, a flow passageway extending through said body connecting said cavity to said outlet port, and a flexible membrane sealingly secured at its periphery to said body surface and overlying said inlet port, said cavity and said outlet port, the portions of the flexible membrane which overlie said inlet and outlet ports serving as closures for said ports; a diluent supply system for supplying a regulated flow of diluent; a cabinet area for receiving at least one reservoir of concentrate for fluid coupling to said disposable pump inlet port; a pumping station for receiving, retaining and actuating said disposable pump to deliver concentrate from said body outlet port; means for combining the flow of diluent and pumped concentrate; and a control system for controlling operation of said pumping station to operate said disposable pump in a manner to meter the flow of pumped concentrate, so that concentrate and diluent are combined in a selected ratiometric mixture of concentrate and diluent.

86. A beverage dispenser according to claim 85, wherein said pumping station includes a pump actuator having a drive face to which a side of said flexible membrane opposite from said disposable pump body cavity is coupled, said drive face being in fluid communication with sources of positive and negative pressure for moving said flexible membrane into and out of said cavity to pump concentrate from and draw concentrate into said cavity, said pump actuator having first and second valve actuators to open and close said inlet and outlet ports of said disposable pump, and including clamping means for clamping said disposable pump to said drive face.

87. A beverage dispenser according to claim 85, wherein said diluent supply comprises a water supply fluid coupled to a diluent inlet to said disposable pump body, and including diluent cooling means, flow meter means for detecting the flow of diluent, and a flow control valve to supply the regulated flow of diluent to said diluent inlet.

88. A beverage dispenser according to claim 87 wherein said flow meter means is a turbine flow meter.

89. A beverage dispenser according to claims 87, wherein said flow control valve is a variable orifice valve.

90. A beverage dispenser according to claim 87, wherein said flow control valve is an on/off flow control valve.

91. A beverage dispenser according to claim 87, including an on/off diluent valve in fluid circuit with said flow control valve.

92. A beverage dispenser according to claim 86, wherein said disposable pump body has a diluent inlet and said diluent supply system delivers diluent to said clamping means and to said disposable pump body diluent inlet when said clamping means clamps said disposable pump to said drive face.

93. A beverage dispenser according to claim 92, wherein diluent is delivered to said body diluent inlet through a diluent supply line and including, immediately upstream of said disposable pump, a closure for said diluent supply line.

94. A beverage dispenser according to claim 86, wherein said diluent cooling means comprises a refrigerated water bath containing a refrigerant coil for chilling the water bath and a diluent coil in the water bath and through which the diluent flows.

95. A beverage dispenser according to claims 85, including means for refrigerating said cabinet area for receiving the at least one reservoir of concentrate.

96. A beverage dispenser according to claim 85, including means for monitoring the temperature within said cabinet area.

97. A beverage dispenser according to claim 85, including a rigid enclosure for retaining a reservoir of concentrate, said reservoir of concentrate being received in said cabinet area while within said rigid enclosure.

98. A beverage dispenser according to claim 97, wherein a bottom interior surface of said rigid enclosure is angled so that, when said rigid enclosure and reservoir are received in said cabinet area, concentrate in said reservoir will gravitationally flow toward a lower front region of the reservoir, said disposable pump being fluid coupled to said region.

99. A beverage dispenser according to claim 98, wherein said bottom interior surface of said rigid enclosure is angled relative to horizontal in the range of about 12 to 25 degrees.

100. A beverage dispenser according claim 98, wherein a lower surface of said cabinet area is at an angle corresponding to the angle of the bottom interior of said rigid enclosure.

101. A beverage dispenser according to claim 97, including a temperature probe, said rigid enclosure having a hole therein and said temperature probe extending through said hole, said temperature probe protruding from said cabinet area and being in contact with said flexible reservoir within said rigid enclosure in an area of said reservoir in proximity to said disposable pump, so that said temperature probe provides a temperature reading substantially indicative of the temperature of concentrate being pumped.

102. A beverage dispenser according to claim 85, said disposable pump body having a plurality of cavities therein, said pumping station including a pump actuator, having a drive face, to which to which said disposable pump body is releasably attached with a side of said flexible membrane opposite from said cavities against said drive face, said drive face having a plurality of recesses therein corresponding to and aligning with said body cavities, and including sources of negative and positive pressure, said drive face recess being fluid coupled to said sources of negative and positive pressures for alternately having negative and positive pressures applied to said recesses and thereby to said flexible membrane opposite from said pump body cavities to move said membrane out of and into said cavities to draw concentrate into said cavities through said inlet port and to pump concentrate out of said cavities through said outlet port, said pump actuator further having first and second valve actuators operable to open and dose said inlet and outlet ports of said disposable pump, and including clamping means for releasably clamping said disposable pump to said pump actuator.

103. A beverage dispenser according claim 86, wherein said source of positive pressure comprises a pressure pump, a pressure release valve and a pressure regulator to control the pressure being provided to said disposable pump.

104. A beverage dispenser according to claim 103 wherein said pressure regulator is controlled to provide a pressure regulated in accordance with the viscosity of concentrate being pumped.

105. A beverage dispenser according to claims 103, further including valve means associated with each recess on said drive face for switching the regulated pressure on and off.

106. A beverage dispenser according to claim 105, wherein said valve means controls both the pressure switching and regulating functions.

107. A beverage dispenser according to claims 102, including a vacuum pump for providing vacuum, and vacuum valve means for selectively coupling the vacuum provided by said vacuum pump to said recess on said drive face.

108. A beverage dispenser according to claim 107, wherein the vacuum provided by said vacuum pump is coupled to said drive face recesses through a vacuum line, and including a sensor for detecting the presence of concentrate in the line.

109. A beverage dispenser according to claim 108 wherein said sensor comprises an optical sensor.

110. A beverage dispenser according claim 102, wherein fluid communication of said drive face with said source of pressure includes a pressure reservoir and said source of vacuum includes a vacuum reservoir.

111. A beverage dispenser according to claim 110, including a selectively openable drain in the bottom of each of said pressure and vacuum reservoirs.

112. A beverage dispenser according to claim 86, wherein said disposable pump inlet port has a lip therearound and said first valve actuator protrudes through said pump actuator drive face and is operable to selectively move said flexible membrane onto said inlet port lip to close said inlet port.

113. A beverage dispenser according to claim 112, wherein said first valve actuator is driven by a solenoid.

114. A beverage dispenser according to claim 86, wherein said disposable pump outlet port has a lip therearound and said second valve actuator protrudes through said pump actuator drive face and is operable to selectively move said flexible membrane onto said outlet port lip to close said outlet port.

115. A beverage dispenser according to claim 114, including means for driving said second valve actuator in a proportional manner, such that the degree of opening of said outlet port can be controlled to vary the flow of concentrate through said outlet port.

116. A beverage dispenser according to claim 115, wherein said means for driving said second valve actuator comprises a stepper motor.

117. A beverage dispenser according to claim 116, wherein said stepper motor is overdriven in its closed position and then re-zeroed every time said outlet port is closed.

118. A beverage dispenser according to claim 86, said pump actuator including a rolling diaphragm seal between said valve actuators and said drive face.

119. A beverage dispenser according to claim 86, wherein said first and second valve actuators include relatively soft flexible membrane contacting tips.

120. A beverage dispenser according to claim 102, said pump actuator including a gasket surrounding said drive face recesses for forming a seal with said disposable pump, so that application of positive and negative pressures only affect said flexible membrane whereat it overlies said disposable pump cavities.

121. A beverage dispenser according to claim 86, wherein said pumping station is adapted to receive a disposable pump having two pump cavities.

122. A beverage dispenser according to claims 85, wherein said beverage dispenser includes a plurality of pumping stations.
